(19) United States
(12) Patent Application Publication
(10) Pub. No.: US 2003/0129354 A1
(43) Pub. Date: Jul. 10, 2003

(54) FLOOR MAT EXHIBITING REDUCED RIPPLING EFFECTS AND IMPROVED DELAMINATING CHARACTERISTICS OF ITS TUFTED PILE FIBERS

(76) Inventors: WILLIAM O. BURKE III, LAGRANGE, GA (US); JAMES N. ROCKWELL, LAGRANGE, GA (US); ROBERT C. KERR, LAGRANGE, GA (US)

Correspondence Address: MILLIKEN & COMPANY, 920 MILLIKEN RD, PO BOX 1926, SPARTANBURG, SC, 29304, US

(21) Appl. No.: 09/128,289

(22) Filed: Aug. 3, 1998

(51) Int. Cl. B32B 33/00; D05C 17/02

(52) U.S. Cl. 428/95

(57) ABSTRACT

This invention relates to a floor mat which comprises a nonwoven substrate through which carpet pile fibers are tufted and which also comprises either a foam rubber backing sheet which exhibits the same degree of shrinkage as the carpet pile component or a rubber backing sheet which possesses a strength modulus above about 1,000 pounds per square inch. With such backing sheet requirements either the overall shrinkage of the mat will be even or the backing sheet will be strong enough to compensate for varying degrees of shrinkage between the pile substrate and the backing sheet. The resultant floor mat is the first such mat which meets industrial laundry standards of rippling (i.e., curling up) and delaminating (i.e., loosening and ultimate falling out of tufted pile fibers) which also utilizes a nonwoven carpet pile substrate and which must also be able to withstand vigorous laundry processes without either damaging the subject rotary washer or centrifugal dryer or become damaged itself upon exposure to such harsh conditions.

### FIELD OF THE INVENTION

This invention relates to a floor mat which comprises a nonwoven substrate through which carpet pile fibers are tufted and which also comprises a foam rubber backing sheet which exhibits the same degree of shrinkage due to heat exposure as the carpet pile component. The resultant floor mat is the first such mat which meets industrial laundry standards of rippling (i.e., curling up) and delaminating (i.e., loosening and ultimate falling out of tufted pile fibers) which also utilizes a nonwoven carpet pile substrate.

### DISCUSSION OF THE PRIOR ART

Floor mats have long been utilized to facilitate the cleaning of the bottoms of people's shoes, particularly in areas of high pedestrian traffic such as doorways. Moisture, dirt, and debris from out of doors easily adhere to such footwear, particularly in inclement weather and particularly in areas of grass or mud or the like. Such unwanted and potentially floor staining or dirtying articles need to be removed from a person's footwear either prior to entry indoors or someplace within an edifice in order to prohibit, or at least diminish, the transfer or “re-tracking” of dirt and debris from persons' shoes to floor coverings. As will be appreciated, such floor (and/or dust control) mats by their nature must undergo frequent repeated washings and dryings so as to remove the dirt and debris deposited thereon during use. These mats are generally rented from service entities which retrieve the soiled mats from the user and provide clean replacement mats on a frequent basis. The soiled mats are thereafter cleaned and dried in an industrial laundering process, such as in rotary washing machines and centrifugal dryers, and then sent to another user in replacement of newly soiled mats.

Such floor mats have had at least three significant problems arising from frequent washings and harsh environments of use. First, the energy required to wash and dry a typical floor mat is significant due to the overall mass of the mats. This overall mass is made up of the mass of the mat pile, the mass of the carrier fabric into which the mat pile is tufted, and most significantly, the mass of the rubber backing sheet which is integrated to the carrier fabric under heat and pressure. As will be appreciated, a reduction in the overall mass of the floor mat will result in a reduced energy requirement in washing and drying the mat. Moreover, a relative reduction in the mass of both the carpet pile substrate (carrier fabric for the carpet pile) and the rubber backing sheet (the heaviest component) will provide substantial benefits in this area. The floor mat of the present invention includes a carpet pile substrate which must be non-woven and preferably weighs from about 3.5 to about 4.5 ounces per square yard. The rubber backing sheet of the inventive mat may possess a specific gravity which is approximately 25 percent less then the rubber sheets of typical prior floor mats (less than about 0.98) upon addition of a blowing agent during vulcanization in order ultimately to form a foam rubber sheet. Accordingly, with such a decrease in the overall weight of the mat, the overall energy requirements associated with the cleaning and handling of these mats is substantially reduced over that of prior mats. All of these improvements provide a decrease in energy costs which translates into reduced costs for the consumer.

A second problem which is frequently encountered, particularly with laundered floor mats, is the susceptibility of such mats to rippling, or rolling up, of the rubber backing, rubber borders, and carpet pile substrate due to uneven shrinking of those components upon exposure to heat in centrifugal dryers. This problem may result in a mat which will not lie flat on a desired surface without the need for added weight, and thus undesired and aesthetically displeasing obstacles, placed in the areas of curling on the subject mat. The mat of the present invention incorporates a specific rubber composition for the backing sheet and reinforcement borders which either possesses the same degree of shrinkage as the carpet pile substrate or possesses a sufficiently high modulus strength to compensate for any shrinkage variations. Accordingly, the inventive mat represents a useful advancement over the prior art.

A third major problem has been the delamination of carpet pile fibers from woven or knit pile substrates within standard floor mats. By delamination it is meant the carpet fibers will become disassociated from the substrate due to the weakening of the pile substrate over time, particularly upon exposure to the rigors of periodic industrial laundering. Frequently this weakening of the pile substrate occurs unevenly thus resulting in a carpet pile which loses its tufted fibers in discrete areas of the mat. Such delamination, particularly in an haphazard fashion, results in, again, a mat which is aesthetically displeasing. The inventive mat utilizes a specific non-woven pile substrate through which the carpet pile fibers are tufted. Such a non-woven construction provides the desired benefit of reduced capability of delamination by more effectively, more uniformly, and more strongly holding the tufted carpet pile fibers in place throughout the life of the mat, even upon exposure to vigorous laundry processes. The particularly useful non-woven substrate also exhibits a shrinkage rate on a dye range of from about 2.0 to about 2.5% which is well below the standard rate for non-woven substrates of from about 3.5 to about 7.5%. The shrinkage rate of the specific non-woven substrate also matches that of the necessary rubber backing sheet and solid reinforcement borders which, again, provides the beneficial non-rippling effects discussed above. Such a specific non-woven floor mat carpet pile substrate has not been taught or fairly suggested within the prior art to date, particularly in combination with the specific low shrinkage or high modulus strength rubber backing and solid rubber border reinforcement strip compositions.

Floor and/or dust control mats have been developed in the past which provide an easy manner of cleaning the soles of a person's shoes simply by scraping the footwear against such a stiff article. Examples of such floor mats or carpet piles are exemplified in U.S. Pat. Nos. 1,008,618, to Skowronski et al.; 4,045,605, to Breens et al.; 3,306,808, to Thompson, et al.; 4,353,944, to Tarui; 4,741,065, to Parkins; 4,886,692, to Kerr et al.; 5,227,214, to Kerr et al.; 5,305,565, to Nagahama et al.; 5,350,478, to Bojstrup et al.; and 5,680,826, to Nagahama et al.; as well as French Patent No. 1,211,755, assigned to Cosyntex (S.A.) and PCT Application 95/30040, assigned to Kleen-Tex Industries, Inc., all of which are incorporated herein by reference. Nowhere in the prior art is an industrially launderable floor mat comprised of a carpet pile, including a non-woven substrate having a shrinkage rate of about 2.0 to about 2.5%, and a foam rubber backing sheet possessing the same degree of shrinkage as the non-woven carpet pile substrate disclosed or fairly suggested. Nor is there a teaching or fair suggestion to combine a non-woven carpet pile substrate possessing a shrinkage rate of from about 2.0 to about 2.5% with a solid rubber backing sheet having a strength modulus of greater than about 1,000 pounds per square inch. Non-woven carpet pile substrates for use with floor mats have been discussed within the prior art, such as within the Parkins patent, above. However, such disclosures were limited to the possibility of utilizing non-woven substrates as acceptable alternatives to woven, knit, and the like, substrates. There is no teaching which requires or even makes specific mention as to the importance of a specific non-woven carpet pile substrate construction. As a result, a need exists for such an improved, industrially launderable or cleaned, floor mat which is not susceptible to appreciable rippling or delamination of the carpet pile fibers from its carpet pile substrate.

### DESCRIPTION OF THE INVENTION

It is thus an object of this invention to provide a floor (and/or dust) mat which will withstand the rigors associated with rotary washing and centrifugal drying on an industrial scale and is not susceptible to an appreciable amount of rippling upon periodic cleaning. Furthermore, it is an object of the invention to provide a floor (and/or dust) mat which is comprised of a non-woven carpet pile substrate which is not susceptible to weakening of carpet pile tufts and thus will not easily experience delamination of the carpet fibers from the pile substrate. Still a further object of this invention is to provide a floor (and/or dust) mat which comprises a non-woven carpet pile substrate which possesses the same degree of shrinkage as the foam rubber backing sheet of the same mat. Yet another object of the invention is to provide a floor (and/or dust) mat which comprises solid rubber reinforcement borders which possess the same degree of shrinkage as both the non-woven carpet pile substrate and the foam rubber backing sheet. One additional object of the invention is to provide a floor mat which comprises a non-woven carpet pile substrate having a low shrinkage rate with a solid rubber backing sheet having a strength modulus high enough to compensate for rubber sheet shrinkage (due to exposure to conditions such as high washing or drying temperatures) which is greater than the shrinkage rate of the carpet pile substrate in order to provide a floor mat which retains its flat position as vulcanized rather than rolling up. Yet another object of the invention is to provide a floor mat which may be printed with any design, logo, and the like, which will remain aesthetically pleasing over a duration of usual use and industrial laundering.

Accordingly, this invention encompasses a floor mat comprising

a non-woven carpet pile substrate;

a pile material tufted into said non-woven carpet pile substrate which forms a pile surface on one side of said substrate;

a vulcanized expanded rubber backing sheet of rubber integrated to the other side of the carrier fabric,

wherein said rubber backing sheet comprises a blowing agent to produce a closed cell structure foam rubber; and

optionally, solid vulcanized rubber reinforcement strips present along at least a plurality of borders of said floor mat;

wherein said floor mat possesses suitable flexibility to be laundered on a regular basis in a standard industrial washing machine without appreciably damaging said mat or said machine; and

wherein said non-woven carpet pile substrate possesses a shrinkage factor of from about 2.0 to about 2.5% and said rubber backing sheet possesses a shrinkage factor of from about 2.0 to about 2.5%.

Also encompassed within this invention is a floor mat comprising

a non-woven carpet pile substrate;

a pile material tufted into said non-woven carpet pile substrate which forms a pile surface on one side of said substrate;

a vulcanized expanded rubber backing sheet of rubber integrated to the other side of the carrier fabric; and

optionally, solid vulcanized rubber reinforcement strips present along at least a portion of the borders of the mat;

wherein said floor mat possesses suitable flexibility to be laundered on a regular basis in a standard industrial washing machine without appreciably damaging said mat or said machine; and

wherein said non-woven carpet pile substrate possesses a shrinkage factor of from about 2.0 to about 2.5% and said rubber backing sheet possesses a modulus strength of greater than about 1,000 pounds per square inch.

The inventive floor mat generally comprises any type of standard carpet pile fibers tufted through a non-woven carpet pile substrate which possesses a shrinkage rate of from about 2.0 to about 2.5%. The carpet fibers become attached to the rubber backing sheet upon vulcanization. Such fibers may be natural or synthetic, including, without limitation, cotton, ramie, polyester, nylon, polypropylene, and the like, as well as blends of such fibers. The fibers may be coarse or fine in structure as well. Of particular interest in this invention, however, are 100% solution dyed nylon fibers. Such pile fibers provide the best pile surface for overprinting with different dyes in order to provide the most aesthetically pleasing colorations and shades on the floor mat pile surface.

U.S. Pat. No. 5,585,565, to Nagahama et al., previously entirely incorporated by reference, shows the usual manner of producing floor mats comprising carpet pile fibers, a carpet pile substrate, and a rubber backing sheet. This reference, however, makes no mention as to the importance of a non-woven carpet pile substrate having a particularly low shrinkage rate nor any discussion of the importance of either a similar shrinkage rate for its foam rubber backing sheet or a necessarily high strength modulus for a solid rubber backing sheet. For the inventive floor mat, the attachment of the rubber sheet component to the carpet pile fibers may be accomplished either during the actual vulcanization step, as taught in Nagahama, for example, above, or through the use of an adhesive layer, preferably a polyolefin adhesive, between the carpet pile and the rubber sheet, as disclosed in copending U.S. patent application Ser. No. 08/732,866, to Kerr, hereby entirely incorporated by reference, or any other like procedure.

If the backing sheet is a solid rubber, as noted above, it must possess a modulus strength of greater than about 1,000 pounds per square inch. Modulus strength for rubber is generally defined as the force required to physically stretch cured rubber specimens typically at 300% elongation and is determined by utilization of a tensile tester. The required high modulus strength is very important in this invention for a couple of reasons. Primarily, the non-woven substrate will shrink upon use and periodic industrial laundering while the solid rubber will not shrink at the same rate, if at all. Thus, the high modulus strength solid rubber will not exhibit any rippling effects of the non-woven substrate even with a high variation in shrinkage rates. Furthermore, rippling should not occur with such a high modulus strength solid rubber because the force needed to distort or disfigure the backing sheet will not be met through standard use and industrial laundering.

Solid rubber reinforcement strips may also be added around the borders of the mat, either by hand or in an in-line process, such as in Patent Cooperation Treaty Application 96/38298, to Milliken Research Corporation. Such strips must either possess roughly the same shrinkage rate factor as the carpet pile substrate and the foam rubber backing sheet or they must possess roughly the same modulus strength of the solid rubber backing sheet, all in order to ensure the probability of rippling (or curling) of the mat will be minimal. Such strips may be comprised of any type of butadiene rubber, such as acrylonitrile-butadiene (NBR) or styrene-butadiene (SBR), or carboxylated derivatives of such butadienes, merely as examples. Preferably, the strips are comprised of NBR as carboxylated NBR is cost prohibitive.

The carpet fibers may be colored or dyed through any acceptable method so as to produce aesthetically pleasing designs within the carpet pile portion of the inventive mat. Of particular importance, however, is the utilization of an overprinting procedure of 100% solution dyed nylon fibers. Such nylon is acid-dyeable and available from Cookson Fibers. As noted above, such pile fibers allow for the most pleasing and long-lasting colorations and shades of color to be applied and retained on the pile surface through the utilization of acid dyes. With such fibers, any design or configuration may be produced (as well as logos, pictures, and the like) on the pile surface, again in order to provide a long-lasting aesthetically pleasing floor mat for the consumer. Furthermore, the mat itself can be made in any shape, with rectangular or square configurations being preferred.

As noted above, the inventive floor mat can easily be removed from the floor or ground and can be easily laundered through, preferably, industrial washing processes utilizing standard heavy duty washing machines. For this reason, the inventive floor mat must a backing sheet which possesses suitable flexibility so as not to damage such machinery (not to mention itself) when subjected to such rigorous cleaning procedures. Although the inventive floor mat must withstand the rigors of industrial machine washing, hand washing and any other manner of cleaning may also be utilized. The inventive mat must only be able to withstand such industrial cleaning procedures. As a result, the inventive mat provides a long-lasting article which is easily cleaned, and thus remains aesthetically pleasing to users (i.e., pedestrians) over the life of the mat. All of this translates into reduced cost for the consumer as fewer mats need to be purchased in order to provide a suitable barrier to outdoor dirt and moisture. Furthermore, because of the utilization of a non-woven carpet pile substrate, the carpet pile fibers of the inventive floor mat will, as noted above, remain tufted over a sustained period of time and upon periodic exposure to harsh industrial laundry procedures. Additionally, the inventive floor mat will not be susceptible to curling or rolling up (rippling) and thus will pose a decreased risk of harm to pedestrians when compared to the mats of the prior art. Overall, the inventive floor mat provides an article which will retain its aesthetically pleasing characteristics over a long period of time and which thereby translates into reduced costs for the consumer.

### BRIEF DESCRIPTION OF THE DRAWINGS

FIG. 1 is a schematic representation of a floor mat manufacturing machine.

FIG. 2 illustrates a molded floor mat as it exists within the mat manufacturing machine of FIG. 1.

FIG. 3 is a partial cross-sectional view of a completed vulcanized floor mat of the instant invention.

### DETAILED DESCRIPTION OF THE DRAWINGS

While the invention will be described in connection with certain preferred embodiments and practices, it is to be understood that it is not intended to in any way limit the invention to such embodiments and practices. On the contrary, it is intended to cover all alternatives, modifications and equivalents as may be included within the spirit and scope of the invention as defined by the appended claims.

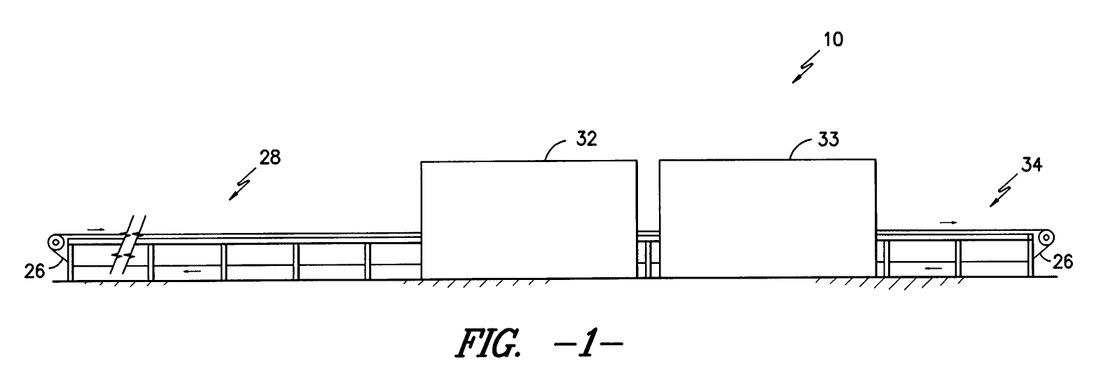

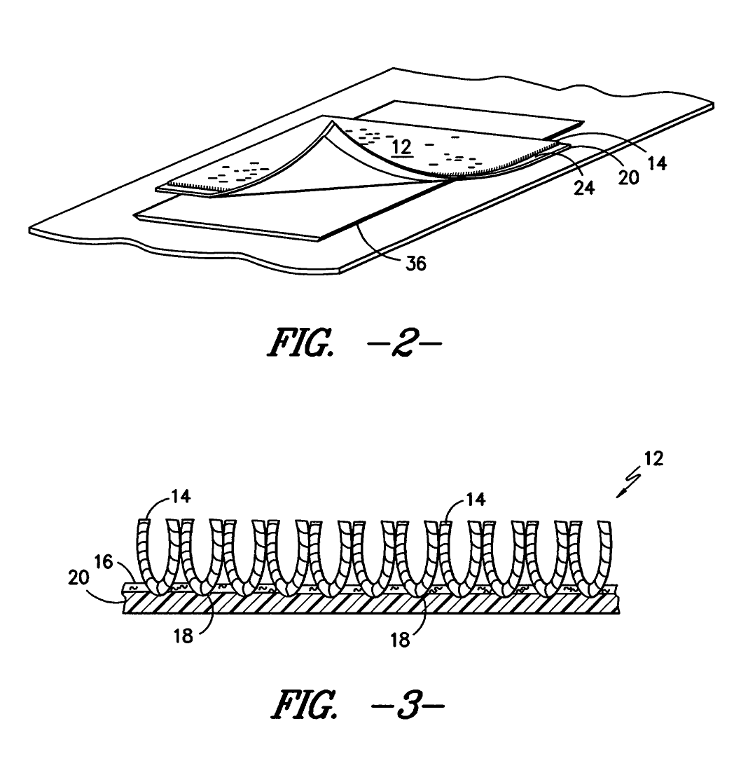

Turning now to the drawings wherein like elements are designated by like reference numerals in the various views, in FIG. 1 is shown a schematic of a floor mat manufacturing machine 10 for producing the floor mat 12 (FIGS. 2 and 3) of the present invention. In the illustrated and preferred form of the invention, the floor mat 12 comprises pile yarns 14 of natural or synthetic fibers (such as cotton, ramie, polyester, nylon, polypropylene, and the like), preferably 100% solution dyed nylon pile fibers, tufted through a nonwoven pile substrate (carrier layer) 16 comprised preferably of polyester (although nylon, polypropylene, cotton, and the like may also be utilized) with the bottom 18 of the tufts adhered to a rubber backing sheet 20. This adherence of the rubber backing sheet 20 to the nonwoven pile substrate 16 and bottom of the tufts is effected during vulcanization (i.e. cross-linking) of the rubber backing sheet under heat and pressure as is well known to those of skill in the art. It is thus of utmost importance for the nonwoven pile substrate 16 to bond well to a backing sheet 20 comprised of either foam or solid rubber in order to produce a long-lasting floor mat. If desired, the bottom of the rubber backing sheet may also include a plurality of anti-creep cleats (not shown) as are well known in the art. As shown in FIG. 2, the floor mat 12 of the present invention also preferably includes a border portion 24 around the perimeter comprised of solid rubber reinforcement strips which become vulcanized simultaneously with the mat. Such border portion strips 24 may be added by hand prior to vulcanization or they may be adhered to the rubber backing sheet 20 through an in-line procedure as taught within U.S. patent application Ser. No. 09/060,739, to Rockwell, Jr. et al.

The floor mat 12 of the present invention is assembled molded and vulcanized on the manufacturing machine 10 of FIG. 1. The manufacturing machine 10 which is well known to those of skill in the art includes an endless, teflon coated conveyor belt 26 to carry the floor mats 12 from an assembly station 28, into a press molding apparatus 32, to a post cure oven 33 and out to a separating station 34. The press molding apparatus 32 can be of any type which is suitable such as that shown in U.S. Pat. No. 4,447,201 to Knudsen (incorporated by reference).

In production of the floor (and/or dust control) mats 12 of the present invention, the mats are preassembled at station 28 by laying down a metal plate or silicone or butyl pad 36 on the conveyor belt 26. The rubber backing sheet 20 as described more fully below is placed over the silicone pad and the tufted fabric comprising the pile yarns 14 tufted through the nonwoven pile substrate 16 is placed on top of the rubber backing sheet 20. In the preferred practice, the rubber backing sheet laid down at the assembly station 28 is a solid calendared sheet of green (i.e. unvulcanized) acrylonitrile-butadiene rubber (NBR).

The conveyor belt 26 is then indexed to place the preassembled mat into the press mold 32 while a second mat is preassembled at station 28. While the first mat is in the press mold 32, it is exposed to a temperature between about 250° F. and about 320° F. While in the press mold 32, the mat is exposed to pressures in the range of between about 20 psi and 40 psi. At the temperature and pressure occurring in the press mold 32, the rubber backing sheet 20 undergoes vulcanization and is integrated to the carrier layer 16 of the mat to form a substantially unitary structure. After about 3 to 6 minutes the conveyor belt 26 is again indexed to move the first vulcanized mat into a post cure oven 33 to complete the vulcanization but without the application of pressure. During this time yet a third mat is preassembled at station 28 while the second mat is indexed to the press mold.

In the preferred practice, the post cure oven is operated at a temperature between about 280° F. and 300° F. but no pressure is applied to the mat. After another 3 to 6 minutes, the conveyor belt is again indexed to move the first mat into the stripping station 34 wherein it is removed from the silicone pad and the conveyor belt 26 (FIG. 2) while the second, and third mats are indexed into the post cure oven 33, and the press mold 32 respectively, and a fourth mat is preassembled at station 28. As will be appreciated, the mat may also undergo a preheating operation prior to entering the press mold if desired as in U.S. Pat. No. 4,886,692, to Kerr.

### DETAILED DESCRIPTION OF THE INVENTION

As noted above, the selection of a particular non-woven carpet pile substrate is of utmost importance within the inventive floor mat. Such a non-woven substrate, again, as noted previously, must exhibit a shrinkage rate factor upon standard use, processing, and industrial cleaning procedures (which includes high temperatures washing and drying) of from about 2.0 to about 2.5%. Standard nonwoven substrates exhibit higher shrinkage rates (from about 3.5 to about 7.5%). Those substrates are thus unacceptable within the inventive mat because the undesired rippling (curling, etc.) effect is not diminished upon utilization of a substrate susceptible to such high degrees of shrinkage through standard use, processing, and industrial cleaning. The carpet pile substrate of the inventive mat must also be capable of bonding easily and effectively to the rubber backing sheet; provide a carrier for the tufted carpet pile fibers of the inventive mat which will not weaken easily, thereby providing a carpet pile substrate which will not suffer from an appreciable amount of delamination; and weigh from about 3.5 to about 4.5 ounces per square yard in order to reduce the overall weight of the mat (particularly if a solid rubber backing sheet is utilized). Of particular interest as such a substrate are those constructed of synthetic fibers, such as polyesters (preferably polyethylene terephthalate), although natural fibers may suffice so long as the finished product meets the required shrinkage rate criteria. The preferred substrate is available from Akzo Nobel under the tradename Colback™ TM135. This article is consists solely of polyester, meets the shrinkage rate, bonding, and non-delamination requirements, and weighs about 4.0 ounces per square yard.

Preferably, the base material for the rubber backing sheet 20 is acrylonitrile-butadiene rubber (NBR) or styrene-butadiene rubber (SBR), just as for the border reinforcement strips, noted above. Other materials which may also be used include, merely by way of example, hydrogenated NBR and carboxylated NBR although the use of these materials may be cost prohibitive. As will be appreciated, the use of NBR or SBR alone is desirable from a cost perspective. However, these materials may be susceptible to oxidation and ozone attack (referred to as ozonation) due to the presence of unsaturated carbon-carbon double bonds, thereby inviting the addition of ozone resistance agents, or even the addition of ethylene-propylene-diene comonomer rubber (EPDM), as disclosed in U.S. patent application Ser. No. 08/637,586, to Kerr. Raw NBR is believed to be available from Bayer under the tradename series Krynac™, such as Krynac™ 34E80 or XN 313. SBR may be purchased from Goodyear Tire and Rubber Company.

In the preferred practice of the present invention, a masterbatch of the polymer components is first prepared by mixing the base rubber (either NBR or SBR) with the additive ozone resistant polymer (EPDM) in the desired ratio along with various stabilizers, processing agents, solubilizers, curing catalysts, pigments or colorants, antioxidants and scavenging agents (ozone resistance agents), and any like additives. Optionally, silica may also be added to provide extra strength to the rubber composition. Stabilizers may include calcium carbonate, for example; waxes can be added as non-limiting processing aids; solubilizers include stearic acid and zinc oxide; curing catalysts include any well known polymerization initiator, including Vulkalent™ and Vulkacit™ series catalysts, from Bayer Fibers, DOTG (di-ortho-tolylguanidine, from Bayer), DETU (diethyl thiourea, from Sovereign Chemical), MBTS (mercapto-benzothiazole disulfide, from Uniroyal Chemical), and TETD (tetraethylthiuram disulfide, from Uniroyal Chemical); carbon black, lamp black, and the like, are useful as pigments; and Octamine™, from Uniroyal Chemical Company, or elemental sulfur can be added to scavenge excess chlorine, oxygen, or ozone. Exemplary compositions of the resultant rubber compositions appear below. These compositions are merely preferred embodiments for the invention and it should be remembered that the main criteria of selection for the particular rubber backing sheet is one which either exhibits roughly the same degree of shrinkage (from about 2.0 to about 2.5% under standard use, processing, and cleaning conditions) as the non-woven carpet pile substrate or a sheet which possesses a strength modulus of greater than about 1,000 pounds per square inch. Thus, any backing sheet which meets these two overall requirements of performance is encompassed within the scope of this invention.

### EXAMPLE 1

### Preferred Foam Rubber Backing Sheet

| Component | Amount (in parts) |
|---|---|
| Krynac^{TM} 34E80 | 30.00 |
| Krynac^{TM} XN 313 | 70.00 |
| N-774 Black¹ | 55.00 |
| Atomite² | 20.00 |
| DINP³ | 30.00 |
| Wax 240 | 1.50 |
| Wax 666 | 2.00 |
| Octamine^{TM} | 1.00 |
| Vanox^{TM} ZMTI⁴ | 1.25 |
| Stearic Acid | 1.50 |
| Zinc Oxide | 3.00 |
| Crystex⁵ | 1.75 |
| DOTG | 0.50 |
| MBTS | 1.25 |
| Celogen^{TM} 754⁶ | 4.00 |
| Vulkalent^{TM} E/C | 1.50 |
| DETU-75 | 1.00 |
| Total Amount | 225.25 parts |

¹Semi-reinforcing carbon black, available from Witco
²Calcium Carbonate
³Antioxidant, diisononyl phthalate, available from Exxon Chemical
⁴Antioxidant, available from R. T. Vanderbilt Co.
⁵Sulfur
⁶Blowing Agent, available from Uniroyal Chemical Co.

The rubber composition is mixed together and eventually formed into a sheet of material. The rubber mixture is thereafter calendared as a solid sheet of unvulcanized material which is used in the manufacture of the floor mat 12 in the process as described above. As previously indicated and shown above, the rubber backing sheet 20 may include, and in some cases preferably includes, a blowing agent to effectuate the formation of closed gas cells in the rubber during vulcanization. The blowing agent which is preferably used is a nitrogen compound organic type agent which is stable at normal storage and mixing temperatures but which undergoes controllable gas evolution at reasonably well defined decomposition temperatures. By way of example only and not limitation, other possible blowing agents which may be used include: azodicarbonamide (Celogen™ AZ-type blowing agents) available from Uniroyal Chemical Inc. in Middlebury Conn. and modified azodicarbonamide available from Miles Chemical in Akron, Ohio under the trade designation Porofor™ ADC-K.

It has been found that the addition of such blowing agents at a level of between about 1 and about 5 parts by weight in the raw rubber composition yields a rubber sheet having an expansion factor of between about 50 and 200 percent. It has been further found that this expansion using these materials yields a final vulcanized rubber backing sheet having a specific gravity of less than about 0.98 and preferably between about 0.5 and about 0.98. With the presence and utilization of a blowing agent during vulcanization, this composition ultimately forms a closed-cell structure foam rubber backing sheet which exhibits a shrinkage rate factor, when exposed to standard use, processing, and industrial cleaning (i.e., rotary washing and centrifugal drying) of roughly about 2.0 to about 2.5%. Furthermore, this backing sheet exhibits a water absorption level of less than about 10%. Such a low level is important to reduce the possibility of warping or puckering of the rubber when used. The foam rubber sheet weighs appreciably less than a solid rubber article, thus, as noted previously, lowering the amount of energy required for proper cleaning and drying of the resultant floor mat on an industrial scale.

The uncured rubber sheet comprising the blowing agent is then assembled with the pile yams 14 and non-woven carpet pile substrate 16 as previously described. The vulcanization of the rubber backing sheet is then at least partially effected within the press molding apparatus 32 wherein the applied pressure is between 20 and 40 psi. Under the high temperatures and pressure, the nitrogen which is formed by the blowing agent partly dissolves in the rubber. Due to the high internal gas pressure, small closed gas cells are formed within the structure as the pressure is relieved upon exit from the press molding apparatus. In the preferred practice the post cure oven 33 is used to complete the vulcanization of the mat and provide additional stability to the resulting product.

### EXAMPLE 2

### Preferred Solid Rubber Backing Sheet

| Component | Amount (in parts) |
|---|---|
| Krynac^{TM} XN 313 | 100.00 |
| N 650 CB¹ | 70.00 |
| Microwhite^{TM} 252 | 25.00 |
| DINP | 30.00 |
| Zinc Oxide | 3.00 |
| Stearic Acid | 1.50 |
| Wax 240 | 1.50 |
| Wax 666 | 2.00 |
| Vanox^{TM} MBPC³ | 3.00 |
| Vanox^{TM} ZMTI | 1.50 |
| Crystex^{TM} | 1.00 |
| MBTS | 0.90 |
| TETD | 0.50 |
| Total Amount | 239.90 |

¹High structure medium reinforcement carbon black, available from Witco
²Calcium carbonate non-reinforcing filler, available from E.C.C. International
³2,2′-methylenebis-(4-ethyl-6-tert-butyl-phenol antioxidant), available from R. T. Vanderbilt Co.

This rubber backing sheet composition exhibited a modulus of about 1,000 pounds per square inch upon vulcanization. In combination with the Colback™ TM135 non-woven substrate, the resultant floor mat exhibited no appreciable rippling after 20 washes.

While the invention has been described and disclosed in connection with certain preferred embodiments and procedures, these have by no means been intended to limit the invention to such specific embodiments and procedures. Rather, the invention is intended to cover all such alternative embodiments, procedures, and modifications thereto as may fall within the true spirit and scope of the invention as defined and limited only by the appended claims.

What I claim is:

1. A floor mat comprising
a non-woven carpet pile substrate;
a pile material tufted into said non-woven carpet pile substrate which forms a pile surface on one side of said substrate; and
a vulcanized expanded rubber backing sheet of rubber integrated to the other side of the carrier fabric,
wherein said rubber backing sheet comprises a blowing agent to produce a closed cell structure foam rubber; and
optionally, solid vulcanized rubber reinforcement strips present along at least one of the borders of the mat;
wherein said floor mat possesses suitable flexibility to be laundered on a regular basis in a standard industrial washing machine without appreciably damaging said mat or said machine; and
wherein said non-woven carpet pile substrate possesses a heat shrinkage factor of from about 2.0 to about 2.5% and said rubber backing sheet possesses a heat shrinkage factor of from about 2.0 to about 2.5%.

2. The floor mat of claim 1 wherein
at least one solid vulcanized rubber reinforcement strip is present and possesses a heat shrinkage factor of from about 2.0 to about 2.5%.

3. The floor mat of claim 1 wherein
said carpet pile substrate is comprised of natural or synthetic fibers; and
said pile material is comprised of natural or synthetic fibers.

4. The floor mat of claim 1 wherein
said carpet pile substrate is comprised of fibers selected from the group consisting essentially of polyester, nylon, polypropylene, cotton, and blends thereof; and
said pile material is comprised of synthetic fibers.

5. The floor mat of claim 1 wherein
said carpet pile substrate is comprised of polyester fibers; and
said pile material is comprised of 100% solution dyed nylon fibers.

6. The floor mat of claim 1 wherein
said carpet pile substrate weighs from about 3.5 to about 4.5 ounces per square yard.

7. The floor mat of claim 1 wherein
said carpet pile substrate weighs from about 4.0 ounces per square yard.

8. The floor mat of claim 1 wherein
silica is added to the rubber backing sheet.

9. The floor mat of claim 1 wherein
said blowing agent forms a solid skin on the surface of the rubber covering the closed cells of the foam rubber.

10. The floor mat of claim 1 wherein
said foam rubber backing sheet possesses a water absorption rate of below about 10%.

11. A floor mat comprising
a non-woven carpet pile substrate;
a pile material tufted into said non-woven carpet pile substrate which forms a pile surface on one side of said substrate;
a vulcanized expanded rubber backing sheet of rubber integrated to the other side of the carrier fabric; and
optionally, solid vulcanized rubber reinforcement strips present along at least a plurality of borders of the mat;
wherein said floor mat possesses suitable flexibility to be laundered on a regular basis in a standard industrial washing machine without appreciably damaging said mat or said machine;
wherein said non-woven carpet pile substrate possesses a shrinkage factor of from about 2.0 to about 2.5%; and
wherein both said rubber backing sheet and said vulcanized solid rubber reinforcement strips possess a modulus strength of greater than about 1,000 pounds per square inch.

12. The floor mat of claim 11 wherein
said carpet pile substrate is comprised of natural or synthetic fibers; and
said pile material is comprised of natural or synthetic fibers.

13. The floor mat of claim 11 wherein
said carpet pile substrate is comprised of fibers selected from the group consisting essentially of polyester, nylon, polypropylene, cotton, and blends thereof, and
said pile material is comprised of synthetic fibers.

14. The floor mat of claim 11 wherein
said carpet pile substrate is comprised of polyester fibers; and
said pile material is comprised of 100% solution dyed nylon fibers.

15. The floor mat of claim 11 wherein
said carpet pile substrate weighs from about 3.5 to about 4.5 ounces per square yard.

16. The floor mat of claim 11 wherein
said carpet pile substrate weighs from about 4.0 ounces per square yard.

17. The floor mat of claim 11 wherein
silica is added to the rubber backing sheet.
